(19) United States
(12) Patent Application Publication
(10) Pub. No.: US 2008/0232679 A1
(43) Pub. Date: Sep. 25, 2008

(54) Apparatus and Method for 3-Dimensional Scanning of an Object

(76) Inventors: Daniel V. Hahn, Ellicott City, MD (US); Donald D. Duncan, Silver Spring, MD (US); Kevin C. Baldwin, Sykesville, MD (US)

Correspondence Address: THE JOHNS HOPKINS UNIVERSITYAPPLIED PHYSICS LABORA;OFFICE OF PATENT COUNSEL, 11100 JOHNS HOPKINS ROAD, MAIL STOP 7-156, LAUREL, MD, 20723-6099, US

(21) Appl. No.: 11/465,165

(22) Filed: Aug. 17, 2006

Related U.S. Application Data
(60) Provisional application No. 60/708,852, filed on Aug. 17, 2005.

(51) Int. Cl. G06K 9/00

(52) U.S. Cl. 382/154

(57) ABSTRACT

A 3-dimensional scanner capable of acquiring the shape, color, and reflectance of an object as a complete 3-dimensional object. The scanner utilizes a fixed camera, telecentric lens, and a light source rotatable around an object to acquire images of the object under varying controlled illumination conditions. Image data are processed using photometric stereo and structured light analysis methods to determine the object shape and the data combined using a minimization algorithm. Scans of adjacent object sides are registered together to construct a 3-dimensional surface model.

### CROSS-REFERENCE TO RELATED APPLICATIONS

This application claims the benefit of prior filed co-pending U.S. application No. 60/708,852, filed on Aug. 17, 2005, the content of which is incorporated fully herein by reference.

### BACKGROUND OF THE INVENTION

1. Field of the Invention

This invention relates to an apparatus and method for scanning an object and constructing a 3-dimensional image thereof.

2. Description of the Related Art

Cuneiform is an ancient form of writing in which wooden reeds were used to impress shapes upon moist clay tablets. Upon drying, the tablets preserved the written script with remarkable accuracy and durability. There are currently hundreds of thousands of cuneiform tablets spread throughout the world in both museums and private collections.

The global scale of these artifacts presents several problems for scholars who wish to study them. It may be difficult or impossible to obtain access to a given collection. In addition, photographic records of the tablets frequently prove to be inadequate for proper examination. Photographs lack the ability to alter the lighting conditions and view direction. This has caused researchers to consider various scanning technologies as a solution to the problems with photographs.

Cuneiform tablets vary from the size of a human torso to the size of a quarter. Scholars estimate that some characters, even in well preserved tablets, contain features as small as 50 μm. This imposes a rather stringent resolution requirement on the cuneiform scanner.

Several technologies exist as potential scanning solutions, including a tri-color laser scanner, a laser line scanner, and conoscopic holography. Each of these technologies relies on laser technology as the illumination source and each has related problems. The tri-color laser scanner and laser line scanner have an inherent trade-off between lateral resolution and depth of field. To achieve the depth of field necessary to scan the entire tablet face in a single pass, the lateral resolution and height accuracy fall below acceptable levels. The conoscopic technique falls short because of its sensitivity to multiple surface reflections of the laser light, for example, V-shaped grooves appear W-shaped.

Because of these problems, there is a need for a non-laser technology for scanning 3-dimensional (3D) objects.

### SUMMARY OF THE INVENTION

As shown in FIG. 1, the object to be scanned is mounted in a fixed position on an elevation stage at the center of a rotary stage. An optional translation stage is available to move the object in the x, y plane if necessary. A camera with a telecentric lens is fixed in position above the object. Additional cameras can be placed around the periphery if desired. Attached to the rotary stage is a light source in the form of a digital projector. The projector is rotated about the object and projects a series of illumination patterns onto the object. These patterns consist of uniform white, red, green and blue illumination and structured light patterns of arbitrary color. Images of the object under each illumination and projector position are acquired. The uniform white projected images are used to obtain estimates of the surface normal of the object using a photometric stereo analysis method. The uniform color projected images are used to obtain a color map of the object. Structured light patterns are used to measure the height of the object with respect to a reference plane.

Normal data from photometric stereo analysis is accurate locally, but does not form a consistent surface and cannot be integrated to obtain a globally accurate object shape. Height data from structured light analysis, on the other hand, is accurate globally but noisy and inaccurate on small local scales. The two data sets are combined to determine the true object shape using the minimization algorithm developed by the inventors as shown in FIG. 2.

The invention, which utilizes incoherent illumination and digital camera technology, combines structured light scanning and photometric stereo. The result is a 3-dimensional scanner that does not use laser scanning and is capable of extremely high resolution scanning (limited by the pixel size of the digital camera) in relatively small amounts of time while also providing color information on the object being scanned. The final scanned image is free of laser speckle and other noise characteristics that are generally encountered with 3-dimensional laser scanning devices.

Prior art scanning technologies do not match the invention's combination of attributes. For example, laser scanners are not as high-resolution, and they are time-consuming and expensive. Scanning electron microscopes are higher in resolution but far more time-consuming and noisy. They also do not provide color information.

### BRIEF DESCRIPTION OF THE DRAWINGS

FIG. 1 is a schematic of the scanner of the invention.

FIG. 2 is a block diagram of the method of the invention including the minimization algorithm utilized in the invention.

FIG. 3, consisting of FIGS. 3A and 3B, illustrates views of a cuneiform tablet under varying illumination directions.

FIG. 4, consisting of FIGS. 4A, 4B, 4C, and 4D, illustrates raw structured light data of the background (4A) and tablet (4B) with the plots, 4C and 4D, illustrating respective center vertical line profiles.

FIG. 5, consisting of FIGS. 5A, 5B, 5C, and 5D, compares φ (5A) and Φ (5B) on a set of background data of the same projection frequency with the plots, 5C and 5D, illustrating respective center vertical line profiles.

FIG. 6, consisting of FIGS. 6A and 6B, illustrates meshed surface maps of a 2.68 mm by 2.68 mm cross-section of a cuneiform tablet showing the structured light height map (6A) and final surface (6B).

FIG. 7, consisting of FIGS. 7A, 7B, 7C, and 7D, illustrates the x- (7A and 7B) and y- (7C and 7D) components of the normal vectors over a 2.68 mm by 2.68 mm cross-section of a cuneiform tablet as measured by the method of photometric stereo (7A and 7C) and computed from the final surface (7B and 7D).

FIG. 8, consisting of FIGS. 8A and 8B, illustrates height profiles of the tablet. Circles represent the structured light height map while a local integration of the normal data is shown with squares and the stars are the final surface (10 iterations).

FIG. 9, consisting of FIGS. 9A and 9B, illustrates a comparison of a cuneiform tablet in a photograph (9A) and as scanned using the invention (9B).

FIG. 10, illustrates the ability of the invention to display zoomed-in views of the tablet as the distance from the top to the bottom in the figure is approximately the diameter of a quarter.

### DETAILED DESCRIPTION

While the impetus for the development of the 3-dimensional scanner of the invention was the desire to improve the 3-dimensional scanning of artifacts such as cuneiform tablets and the invention is, therefore, discussed primarily in that context, it is to be understood by those skilled in the art that this description is made only by way of example and not as a limitation to the scope of the invention which should be understood to cover the use of the invention to provide a 3-dimensional scan of other objects as well.

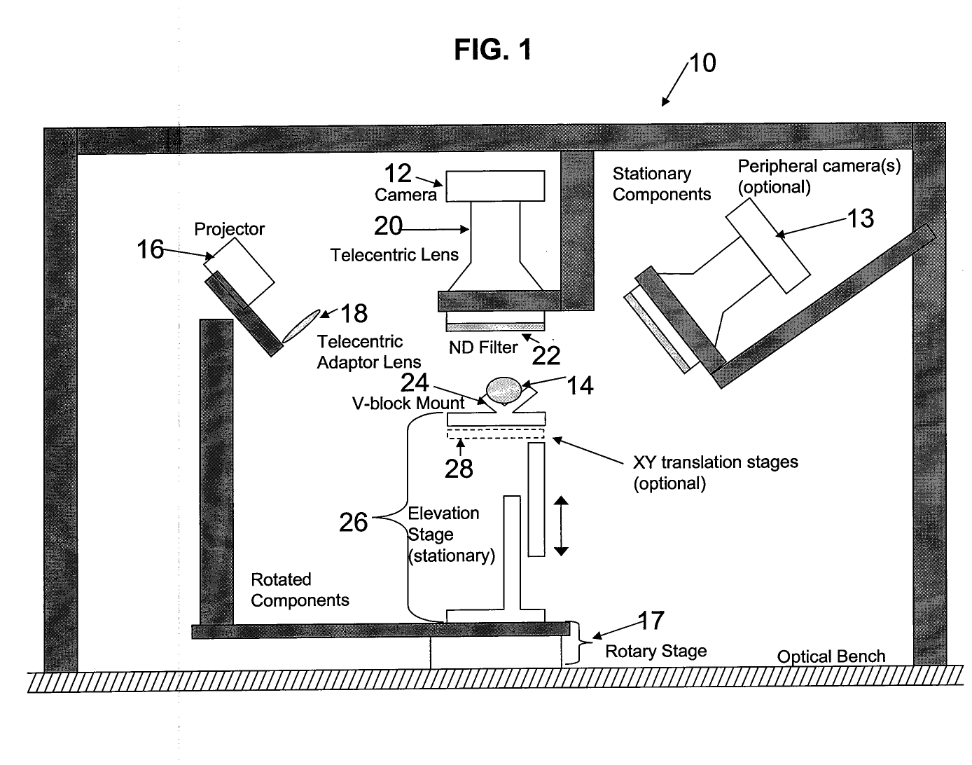

A schematic of the scanner of the invention is shown in FIG. 1. The scanner 10 uses camera 12 (by way of non-limiting example, a Lumenera Lu120). Optionally, one or more additional cameras 13 may be placed around the periphery of the object so that the sides and upward facing portion of the object can be analyzed in a single scan, thereby resulting in 1) faster data acquisition via a reduced number of scans and 2) minimal handling of the object. Both the camera and the object 14 to be scanned (for example, a cuneiform tablet) are fixed in position to maintain image registration. A light source 16 is affixed to a rotary stage 17. The lighting conditions on the object are varied by rotating the light source about the object using the rotary stage and by projecting different illumination colors and patterns (the polar angle of the light source is fixed). This technique maintains exact registration between the object and camera.

By way of non-limiting example, an InFocus LP120 digital projector can be used as the light source as it provides excellent illumination uniformity, can easily project custom patterns, and, through the use of an additional lens, provides adequate collimation. A lens 18 placed in front of the projector is chosen to approximate a telecentric configuration when used in combination with the output lens of the projector.

A telecentric lens 20 is attached to the camera. By way of non-limiting example, an Edmund Optics 0.25× telecentric lens can be used to magnify the field of view of each pixel by a factor of four (26.8 μm by 26.8 μm). As will be clear to those of ordinary skill in the art, other camera/telecentric lens combinations can be used to achieve different resolutions. Sharp image focus is obtained by attaching a neutral density (ND) filter 22 to the telecentric lens so that the iris of the lens remains open. A Vblock 24 mounted on top of a fixed elevation stage 26 is used to position the object within the focal range of the telecentric lens. For larger objects an optional translation stage 28 can be added to permit 2-dimensional (xy) movement of the object.

As noted above and discussed below, in operation the light source is rotated around the object projecting red, green, and blue for color analysis, white for fine-resolution shape (photometric stereo illumination), and sinusoidal patterns for course resolution shape (structured light illumination). The images taken by the one or more cameras are then analyzed as discussed below, and a 3-dimensional image of the object is constructed as a result.

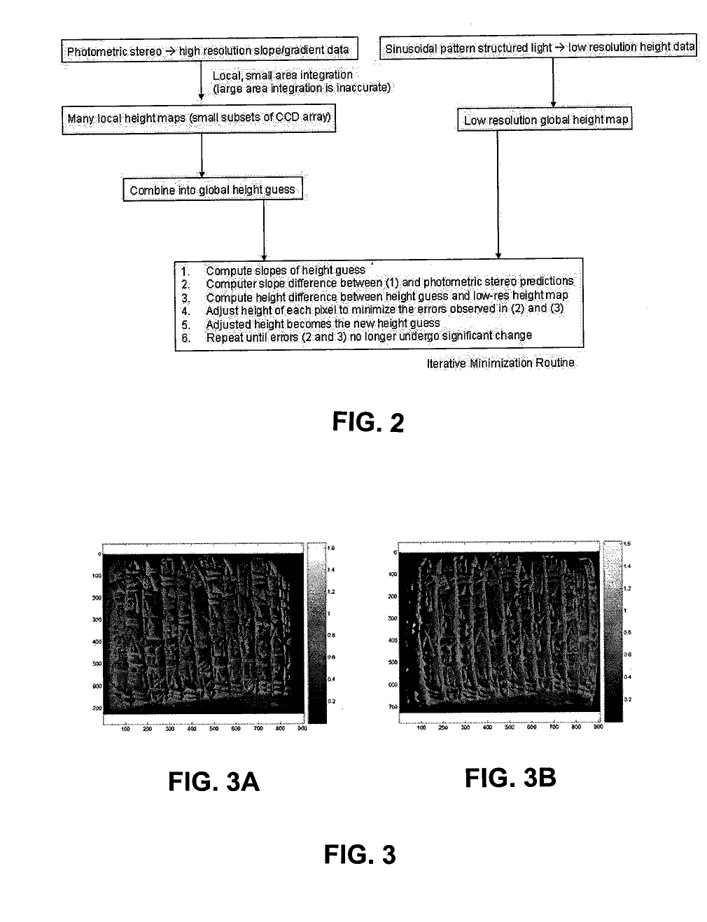

FIG. 2 illustrates the overall method of the invention which will now be discussed in greater detail.

In general, color information is obtained by illuminating the object with solid primary colors over various azimuthal angles. Shape information is obtained in two ways, photometric stereo analysis and a form of structured light analysis. Each image is preprocessed upon data acquisition to correct for camera noise and non-linearity.

A photometric stereo analysis method is used to obtain a surface normal map of the object. This is accomplished by acquiring a plurality of scanned images over various azimuthal angles under collimated white illumination. The brightness of each pixel in each image is dependent upon the illumination, view, and normal directions as well as the bi-directional reflectance distribution function (BRDF) of the surface. Given the data and known illumination and view directions, the normal map and reflectance are estimated.

Normal data resulting from photometric stereo analysis can be integrated over small areas to obtain good estimates of the surface height. Unfortunately, the normal map does not form a conservative (i.e., integrable) surface and small errors accumulate when integration is attempted over larger areas; in short, the data are locally accurate but suffer larger scale inaccuracies.

The particular structured light analysis method implemented in this embodiment of the invention projects a series of 1-dimensional sinusoidal patterns onto the object at a fixed polar and various azimuthal angles. Four patterns, each out of phase with one another by 90°, are projected for each of a series of iteratively doubled frequencies starting with only one quadrant of a sine wave over the entire projector array and ending with 128 periods. The finest resolution projects each sinusoidal cycle over a lateral distance of approximately 0.6 mm.

Each of the plurality of scanned images of different phase for a single frequency is used to determine an absolute phase that is unaffected by variations in surface reflectance. This processing is performed via the Carré technique of phase-measurement interferometry. The resulting images are compared to images of a flat white background to calculate the phase difference and corresponding relative object height.

The resulting height data, although sampled at the same resolution as the normal data, are inherently lower in resolution. This results in characteristics that are the opposite of the normal data—globally accurate but of low resolution. Together, however, the two analysis techniques form a synergistic data set that contains all information necessary to construct an accurate 3-dimensional surface map of the object.

The photometric stereo analysis method is used to calculate the surface normal map of the object. The main premise of the method is that a surface will appear brighter when the illumination direction converges towards the surface normal. This concept is illustrated in FIG. 3, which shows two images acquired under opposite azimuthal illumination directions. The image on the left (FIG. 3A) is of a cuneiform tablet being illuminated from the left; the image on the right (FIG. 3B) of right illumination. As can be seen, sections of the tablet which are sloped toward the left appear bright in the left image but dark in the right image. Likewise, rightward slopes are brighter in the image on the right.

Mathematically, the intensity values of the point (x, y) for a series of images acquired under uniform and collimated illumination are written as

Ī=Q N̅ n̅, (1)

where Q is the reflectance of the point, N̅ is a matrix which describes the directions of incident illumination, and n̅ is the surface normal at (x, y). This equation assumes a Lambertian BRDF. Although only three images are required to uniquely invert Eq. 1, more are used and a least squares approach taken to reduce error and to account for shadowed facets. Defining the z-axis to point downward from the camera towards the tablet, Eq. 1 becomes

$$[ \begin{matrix}{I}_{1} \\ ⋮ \\ {I}_{K}\end{matrix} ] = Q [ \begin{matrix}sin ( θ ) sin ( {φ}_{1} ) & sin ( θ ) cos ( {φ}_{1} ) & - cos ( θ ) \\ ⋮ & ⋮ & ⋮ \\ sin ( θ ) sin ( {φ}_{K} ) & sin ( θ ) cos ( {φ}_{K} ) & - cos ( θ )\end{matrix} ] [ \begin{matrix}{n}_{x} \\ {n}_{y} \\ {n}_{z}\end{matrix} ] , \qquad ( 2 )$$

where θ is the polar angle and φ is the azimuthal angle. The least squares solution is

Q n̅=(( N̅^{T} N̅)⁻¹ N̅^{T})Ī. (3)

Note that the values used for Ī are background corrected image values; these are obtained by dividing the object images by the corresponding background images.

As previously noted, the normal map resulting from this approach does not form a conservative surface due to the nature of the point-by-point calculations. Integration from the normal map to a height field is path-dependent and results in unrealistic shapes when performed on a global scale. To counter these problems, structured light data are incorporated into the final surface determination.

The basic premise of the structured light analysis method employed in the invention is to measure the phase shift of a sinusoidal pattern projected onto the object versus onto a flat background. The resulting phase difference is proportional to the relative object height where the constant of proportionality is determined by applying the technique to a flat object of known height.

There are three main problems with the above approach. First, each projection angle results in some of the object features being shadowed. This problem is easily resolved by using multiple projection angles and statistical analysis to intelligently select an appropriate final value of the phase difference at the point (x, y). Any remaining “holes” in the data are filled when the data is combined with the normal map to construct the final surface.

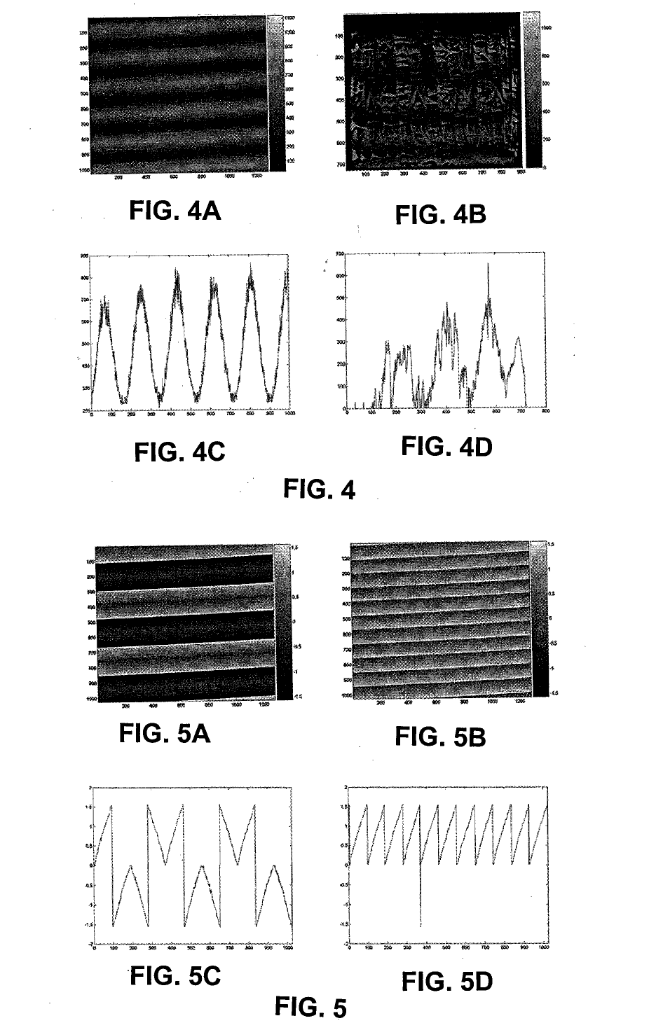

The second problem with this approach is that illumination non-uniformities, camera noise, and variations in surface reflectance and orientation make it difficult to accurately measure the phase. This is illustrated in FIG. 4, which shows raw structured light images of the background (left) (FIG. 4A) and the cuneiform tablet (right) (FIG. 4B) along with vertical line profiles through the centers of the images (FIGS. 4C and 4D, respectively). As can be seen from the background data, it is difficult to construct a perfect sinusoid even with a flat target surface.

When viewing a textured object such as a cuneiform tablet, changes in surface reflectance and orientation mask the sinusoidal profile and make it impossible to accurately measure phase. Use of the Carré technique of phase-measurement interferometry solves this problem as it does not depend on local reflectance or illumination level. This technique requires that four images of differing phase shifts be acquired. An absolute value of the phase is then calculated via the relation

$$ϕ = {tan}^{- 1} [ \frac{\sqrt{( {I}_{1} - {I}_{4} + {I}_{2} - {I}_{3} ) ( 3 ( {I}_{2} - {I}_{3} ) - ( {I}_{1} - {I}_{4} ) )}}{{I}_{2} + {I}_{3} - {I}_{1} - {I}_{4}} ] . \qquad ( 4 )$$

This equation, however, is not the final solution; the resulting phase is in fact ambiguous due to the range of the inverse tangent function (φ is bound to ±π/2). The value of φ depends upon the order in which the intensity values Iₖ are input to Eq. 4. In addition, the wrapping of the inverse tangent function causes alternating periods of the phase to switch from ascending to descending values; this in turn causes problems when attempting to calculate the phase difference between object and image data.

Resolution of these problems requires that the intensity values be input in a consistent order amongst all points (x, y). Since determining this order requires full calculation of the phase four times, it is easier to choose a consistent phase value from among the four calculated values. In particular, the second positive value is chosen by applying the selection algorithm

$$Φ = {ϕ}_{1} \times ( {ϕ}_{4} > 0 ) + {\sum }_{k = 2}^{4} {ϕ}_{k} \times ( {ϕ}_{k - 1} > 0 ) , \qquad ( 5 )$$

where φ₁ through φ₄ are calculated by varying the order of the input intensity values in Eq. 4. The necessity of this operation is illustrated in FIG. 5, which compares φ (FIGS. 5A and 5C) and Φ (FIGS. 5B and 5D) calculated from the same set of raw background data. While φ alternates between ascending and descending slopes and has a range of ±π/2, Φ is always ascending and ranges from 0 to π/2. This range limitation is the negative consequence of implementing the selection algorithm. It is for this reason that absolute certainty of the phase of a given point (x, y) requires that the period of the lowest frequency sinusoid be four times the width of the projected image (that only ¼ of the cycle be projected).

This limitation on the projected sinusoid leads to the third and final problem associated with the implemented structured light analysis method. In short, the greater the period, the greater the measurement error. Fortunately, countering this problem is much more straightforward than the last. An iterative approach is taken in which the frequency of the projected sinusoid is doubled and the resulting phase used to refine the original value. Looking at the solution from the opposite perspective, the highest resolution sinusoid is used to determine the phase and the iteratively frequency-halved sinusoids are used to resolve the ±nπ/2 ambiguities.

The shortcoming of this structured light analysis method, or rather, its implementation, is its low resolution. The projector has a resolution of 1024×768, which overfills the area viewed by the camera (1280×1024 resolution). This results in a noisy, over sampled and low resolution surface (in comparison to the normal map). However, the benefit of this technique is its high level of global accuracy, which is unattainable by the photometric stereo analysis method.

Each of the previously described measurement approaches has shortcomings that prevent it from being a stand-alone solution to the scanning needs of the application. Together, however, they compose a complementary data set that contains all information necessary to construct an accurate surface map of the tablet.

The normal map resulting from photometric stereo analysis does not form a conservative surface and integration of the data yields global shape inaccuracies. The resolution of the normal data, however, is excellent. Structured light measurements, on the other hand, provide globally accurate height information that is inherently consistent but low in resolution. An iterative minimization algorithm was therefore designed to combine the data sets in such a way as to take advantage of the benefits of each and to discount the drawbacks.

Two main constraints are incorporated into the minimization algorithm. The first minimizes the error between the slope of the final surface and the normal map on a point-by-point basis, thereby taking advantage of the high resolution of the normal data and avoiding problems due to large-scale integration. The second constraint minimizes the relative height difference between the final surface and a 5×5 median filtered structured light height map. This constraint uses the global accuracy of the height data while removing effects due to isolated noisy data points. A complete description of the algorithm follows.

The height of the tablet surface is updated according to the rule

h(n+1)=h(n)+((1−λ)δh_{PMS}+λδh_{SL}). (6)

In this equation, δh_{SL} is the difference between the 5×5 median filtered height, h_{SL5}, and the surface height,

δh_{SL}=h_{SL5}−h(n); (7)

λ is a weighting factor bound to the interval [0,0.5],

$$λ = \{ \begin{matrix}{( δ {h}_{SL} / 25 um )}^{2} / 2 ; & δ {h}_{SL} < um \\ 1 / 2 ; & otherwise\end{matrix} ; \qquad ( 8 )$$

and δh_{PMS} is the height error calculated by comparing the shape of the current surface to the normal data,

$$δ {h}_{PMS} ( x , y ) = \frac{χ}{4} [ \begin{matrix}δ {S}_{x} ( x - 1 , y ) - δ {S}_{x} ( x + 1 , y ) + \\ δ {S}_{y} ( x , y - 1 ) - δ {S}_{y} ( x , y + 1 )\end{matrix} ] , \qquad ( 9 )$$

where χ is the length of an image pixel (26.8 μm) and δ S̅ is the slope error,

δ S̅(x,y)= S̅(x,y)− S̅_{PMS}(x,y). (10)

S̅(x,y) is the slope as calculated from the surface height,

$${S}_{x} ( x , y ) = \frac{h ( x - 1 , y ) - h ( x + 1 , y )}{2 χ} ; \\ {S}_{y} ( x , y ) = \frac{h ( x , y - 1 ) - h ( x , y + 1 )}{2 χ} , \qquad ( 11 )$$

and S̅_{PMS}(x,y) is the slope measured by photometric stereo analysis,

$${\overline{S}}_{PMS} ( x , y ) = - \frac{{n}_{x}}{{n}_{z}} \hat{x} - \frac{{n}_{y}}{{n}_{z}} \hat{y} . \qquad ( 12 )$$

The initial guess, h(0), used in the algorithm is a 4×4 block-integrated surface (the x and y-slope maps are combined and locally integrated using the Fried algorithm (see Barchers, J. D., Fried, D. L., “Evaluating the Performance of Hartman Sensors in Strong Scintillation,” Appl. Opt., V. 41, pp. 1012-1021, 2002), where the shape of each block is determined by integration of the normal data. The center-height of each block is set to the average height over the region as measured by structured light analysis. An average height adjustment of less than 1/100 of the pixel size (0.268 μm) is used as the exit criterion for the algorithm, with the added constraint that at least 10 iterations be performed.

Adjacent object scans are typically acquired at 60° view increments by manually repositioning the object with the Vblock mount along the two major axis of the object. A total of ten scans are required to image the entire object. Overlapping areas of the data are used to register the scans together for display. The end result mimics a rigid body merging of adjacent “faces” of the object. Viewing software, which was written to display the registered data, allows the user to set any desired view and lighting direction, as well as to adjust other shading parameters such as accessibility, curvature, and depth-based shading.

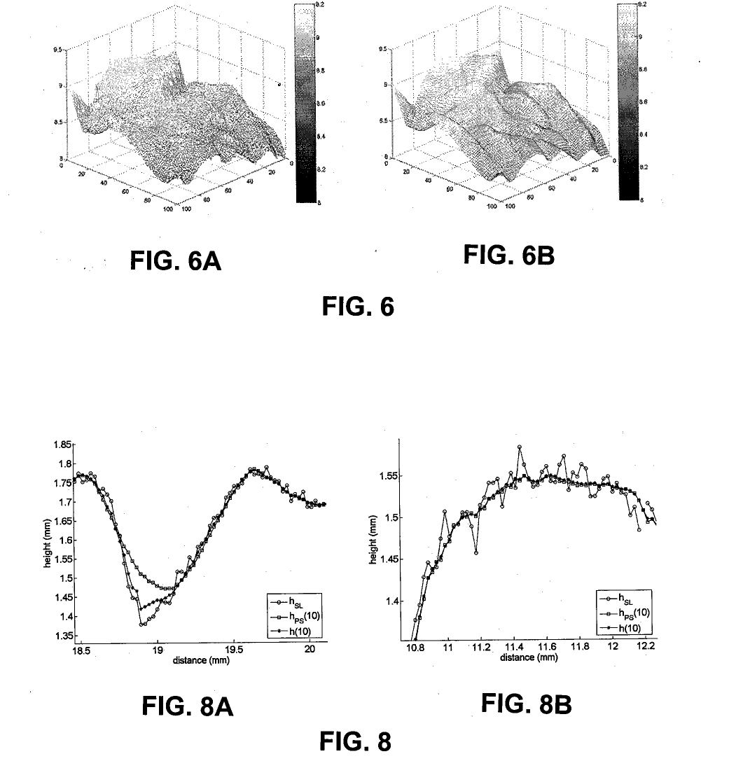

A cuneiform tablet was scanned using the apparatus and methods of the invention described hereto. Meshed surface maps of a 2.68 mm by 2.68 mm cross-section (100×100 pixels) of the “front” of the object are shown in FIG. 6; the left mesh (FIG. 6A) shows the structured light height while the right mesh (FIG. 6B) depicts the final surface. These figures substantiate the claim that the minimization algorithm preserves the global height information resident in the structured light data while discounting the local noise.

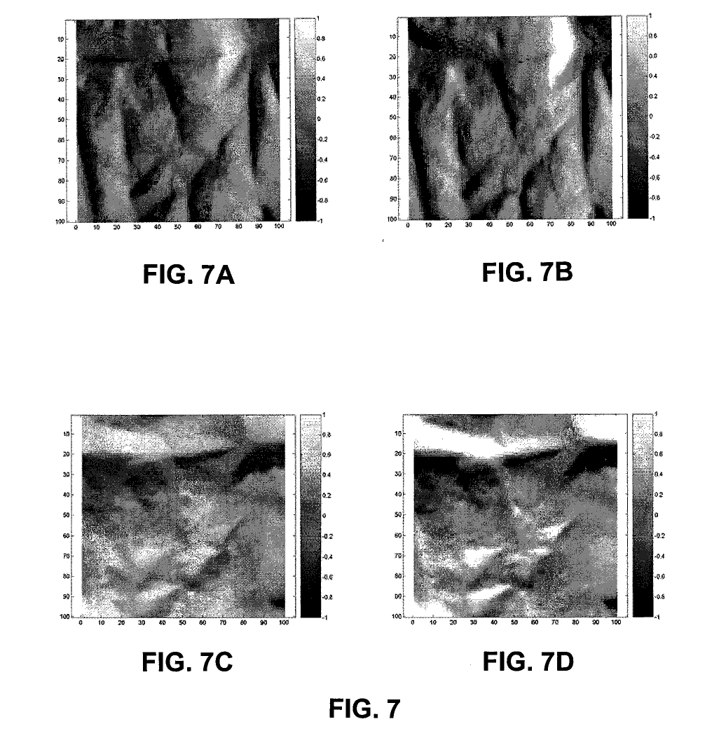

A comparison of the normal vectors of the final surface to those measured by the photometric stereo analysis method over the same area is shown in FIG. 7, which illustrates the x- (7A and 7B) and y- (7C and 7D) components of the normal vectors over a 2.68 mm by 2.68 mm cross-section of a cuneiform tablet as measured by the method of photometric stereo (7A and 7C) and computed from the final surface (7B and 7D).

Overall, the slope information is preserved well. In areas of steep slopes, however, the final surface exhibits a slightly steeper slope than the measured data. This is because the minimization algorithm adjusts the final surface to more closely match the known height, thereby avoiding excessive smoothing of genuine structure.

Height profiles of tablet data are shown in FIG. 8. Circles represent the structured light height map and squares a local integration of the normal data. The stars are the final surface after 10 iterations. Both the normal integration and the final surface suppress the noise of the height data. However, integration is inaccurate with respect to the genuine structure of the tablet in comparison to the minimization algorithm in areas of steep slopes. This is evident in the center valley in the left plot (FIG. 8A). Here, a sharp groove was detected in the structured light data but smoothed over by the integration. The final surface (FIG. 8B), on the other hand, comes within approximately 50 μm of the groove depth as measured by structured light analysis.

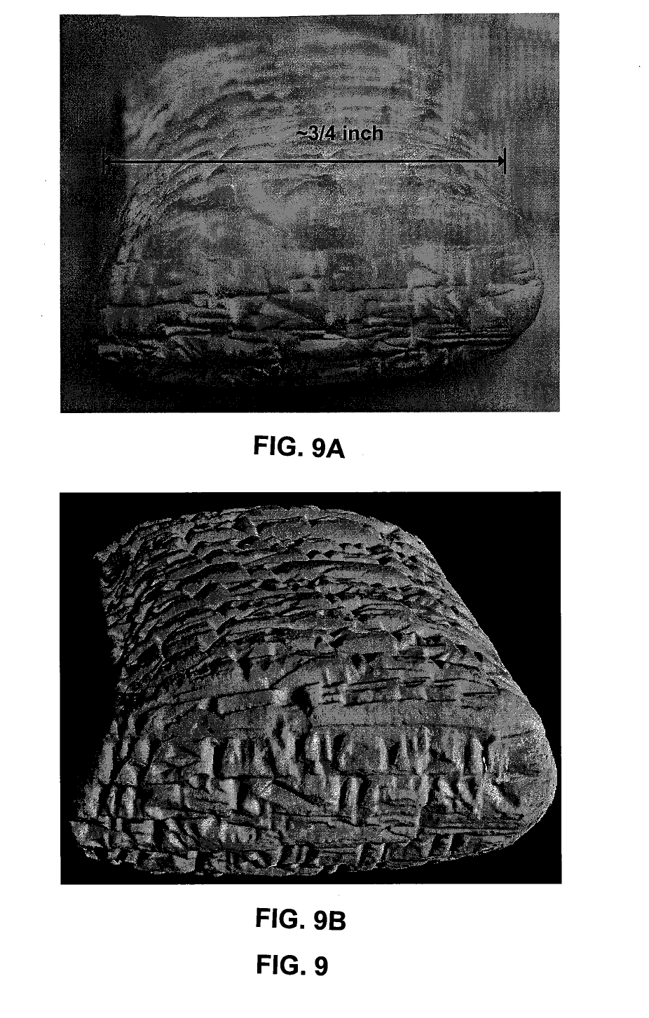

A photograph of the tablet under ambient lighting is shown in FIG. 9A and a 3-dimensional surface model from approximately the same view direction and with the light source towards the right and constructed using the invention is shown in FIG. 9B. The position of the light source was chosen to accentuate the features of the tablet in order to demonstrate the utility of having a 3-dimensional surface model compared to photographic records.

The surface model can be rotated to any orientation and the light source placed in any position so that the best possible view of a given tablet feature may be obtained. The 3-dimensional surface model matches the photograph cuneiform character for cuneiform character and also maintains the gross shape of the tablet. This figure pair also points out one of the distinct features of the 3-dimensional surface model versus a photo. Photos inevitably display a finite depth of field in which some features are in sharp focus and others are blurred. This is not the case for the 3-dimensional surface model which has an inherent infinite depth of field.

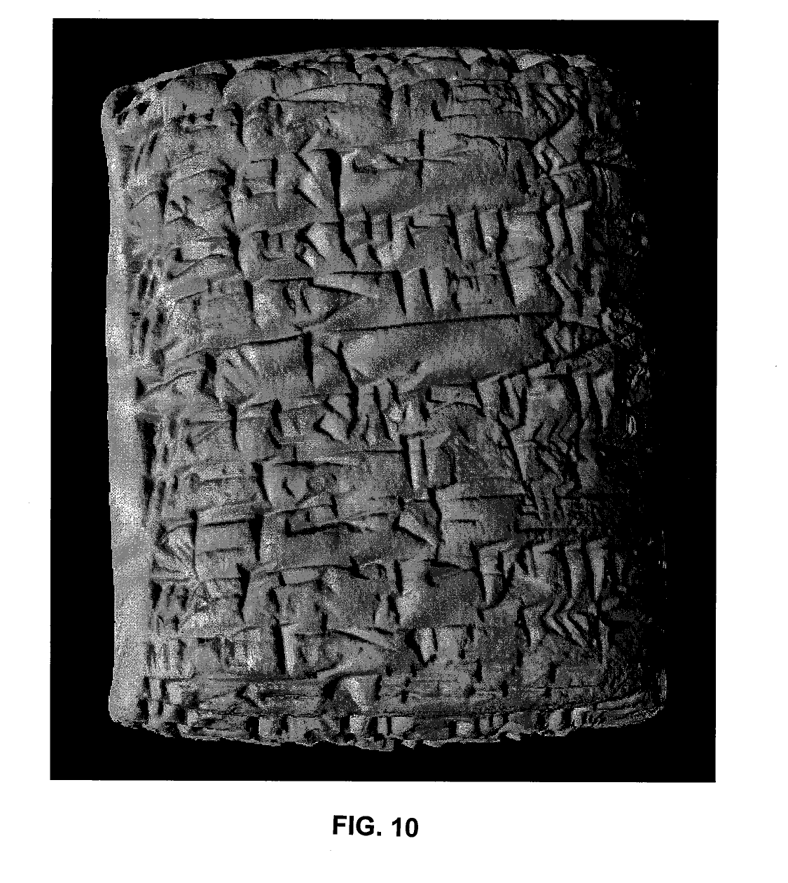

Another 3-dimensional surface model is shown in FIG. 10, wherein the distance from the top to the bottom of the figure is approximately the diameter of a quarter. This clearly shows the ability of the 3-dimensional model and viewing software to display zoomed-in views of the tablet.

The scanner of the invention does an excellent job of determining the surface shape of the cuneiform tablet. It acquires data at 26.8 μm x- and y-sample intervals over an area of approximately 34.3 mm by 27.4 mm. The scanner uses off-the-shelf hardware components, thereby minimizing the system cost and allowing for easy expansion and scalability. The resulting final surface is both globally accurate, in accordance with height information as measured by a structured light analysis method, and locally accurate, in accordance with slope information obtained by the method of photometric stereo analysis method.

Scans of the various faces of the tablet have been registered together to form a complete 3-dimensional surface model of the tablet. This model and the viewing software allow for examination capabilities that far surpass photographic records.

While there has been described herein the principles of the invention, it is to be understood by those skilled in the art that this description is made only by way of example and not as a limitation to the scope of the invention. Accordingly, it is intended by the appended claims to cover all modifications of the invention which fall within the true spirit and scope of the invention.

We claim:

1. An apparatus for 3-dimensional scanning of an object comprising:
a camera positioned above the object, the camera and object each being fixed in position thereby maintaining image registration;
a light source for illuminating the object with different colors and patterns; and
a means for rotating the light source around the object while the light source illuminates the object.

2. The apparatus as recited in claim 1, further comprising a telecentric lens affixed to the camera.

3. The apparatus as recited in claim 2, further comprising a neutral density filter placed in front of the telecentric lens.

4. The apparatus as recited in claim 1, further comprising a means for moving the object vertically, the object being mounted thereon.

5. The apparatus as recited in claim 4, the means for moving further comprising a Vblock, the object being mounted thereon.

6. The apparatus as recited in claim 1, wherein the light source is a digital projector.

7. The apparatus as recited in claim 6, further comprising a lens for collimation, the lens being placed in front of the digital projector.

8. The apparatus as recited in claim 1, further comprising a translation means for moving the object in an x, y plane.

9. The apparatus as recited in claim 1, further comprising at least one additional camera placed around the periphery of the object, thereby permitting additional areas of the object to be analyzed in a single scan.

10. A method for constructing a 3-dimensional image of an object using a plurality of scanned images of the object, the method comprising the steps of:
calculating a surface normal map of the object using a photometric stereo analysis method on the plurality of scanned images;
calculating a height profile of the object over the surface of the object using a structured light analysis method on the plurality of scanned images; and
combining the surface normal map and the height profile using an iterative minimization method to construct the 3-dimensional image of the object.
